(19) United States
(12) Patent Application Publication
(10) Pub. No.: US 2010/0115452 A1
(43) Pub. Date: May 6, 2010

(54) Methods and Systems for Providing Navigation Bars in a Client Browser for a Client Device

(75) Inventors: Timothy J. Chabot, Carol Stream, IL (US); Gregory J. Athas, Lisle, IL (US); Michael P. Mitchell, Downers Grove, IL (US); Thomas E. Hayosh, Lake Zurich, IL (US); Pawel Bak, Elmwood Park, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: NOVARRA, INC.

(21) Appl. No.: 12/611,666

(22) Filed: Nov. 3, 2009

Related U.S. Application Data
(60) Provisional application No. 61/110,807, filed on Nov. 3, 2008.
(60) Provisional application No. 61/160,602, filed on Mar. 16, 2009.

(51) Int. Cl. G06F 3/048

(52) U.S. Cl. 715/779

(57) ABSTRACT

Methods and apparatus are provided for user interfaces for displaying information content. A request for information content, such as a Uniform Resource Locator (URL), is received at a server. A navigation bar may be generated for display with the information content. The navigation bar may be configured to display links while a user of a client device navigates through the requested information content. The links may be based on the information content or independent of the information content. The navigation bar may be displayed as either a fixed or expandable navigation bar. A structured approach may be used to generate partially customizable navigation bars. Modified information content including the navigation bars may be generated and sent from the server to the client device.

### CROSS REFERENCE TO RELATED APPLICATIONS

The present patent application claims priority under 35 U.S.C. §119(e) to U.S. Provisional Patent Application Ser. No. 61/110,807, entitled “Navbars on DVS Client and High-End Profile” and filed on Nov. 3, 2008, and to U.S. Provisional Patent Application Ser. No. 61/160,602, entitled “Web-Assist” and filed on Mar. 16, 2009, the entire contents of both of which are incorporated herein by reference as if fully set forth in this description.

### FIELD

The application relates generally to the field of displaying information content and network communications. More specifically, the application relates to methods and apparatus for providing content with navigation bars to enhance display of information content on client devices using a client browser.

### BACKGROUND

Today, many worldwide web pages (HTML documents) are available that offer a variety of textual and non-textual content types. On a traditional desktop or laptop computer with a large screen running a standard web browser, these content types are easily arranged and displayed for viewing. For example, web sites for displaying photographic images may deliver a plurality of images for a viewer to examine one at a time. Each image in the plurality of images may be displayed for a fixed amount of time as a slideshow, or may be displayed responsive to input from the viewer, such as clicking on a “next image” button.

At the same time, the field of communications, and more specifically wireless telecommunications, is currently undergoing a radical expansion. This technological expansion allows a small, handheld, electronic device, such as a personal digital assistant (PDA), cellular telephone, pager, and other electronic devices, to connect to the same information sources, such as a web server or database, as one could with a personal computer (PC) and a PC-based browser. Several small device client browsers are available which display content from the web to the handheld devices.

However, these small devices typically lack the screen space, processing power, or navigation capabilities to display web content intended for display on a desktop or laptop computer. Thus, there are a number of techniques client browsers utilize to assist the user in navigating the web pages on the small screens. For example, client browsers may alter the layout of web content, change the positioning of images, or simply not display some web content.

### SUMMARY

In one aspect of the application, a method is provided that includes receiving a request for information content at a server, and retrieving the requested information content. The method further includes modifying the information content to include instructions to display the information content with a first navigation bar and a second navigation bar. The information content is displayed between the first navigation bar and the second navigation bar, and the first navigation bar comprises a plurality of links including a first link based on the information content. The method also includes sending the modified information content from the server.

In another aspect of the application, a method is provided that includes receiving information content at a client device. The information content includes instructions to display the information content with a first navigation bar and a second navigation bar, and the information content is displayed on the client device between the first navigation bar and the second navigation bar. The first navigation bar comprises a plurality of links including a first link based on the information content. The method also includes enabling the first navigation bar and the second navigation bar to move vertically and horizontally from a first portion of the information content to a second portion of the information content as a user navigates through the infatuation content. The information content remains between the first navigation bar and the second navigation bar during navigation.

In still another aspect of the application, a system is provided that include a processor and a memory configured to store instructions that, in response to execution by the processor, cause the system to perform operations. The operations comprise receiving information content including instructions to display the information content with a first navigation bar and a second navigation bar. The information content is displayed between the first navigation bar and the second navigation bar, and the first navigation bar comprises a plurality of links including a first link based on the information content. The operations also comprise enabling the first navigation bar and the second navigation bar to move vertically and horizontally from a first portion of the information content to a second portion of the information content as a user navigates through the information content. The information content remains between the first navigation bar and the second navigation bar during navigation.

These as well as other aspects and advantages will become apparent to those of ordinary skill in the art by reading the following detailed description, with reference where appropriate to the accompanying drawings. Further, it should be understood that the embodiments described in this summary and elsewhere are intended to be examples only and do not necessarily limit the scope of the invention.

### BRIEF DESCRIPTION OF FIGURES

Example embodiments of the application are described herein with reference to the drawings, in which:

FIG. 1 is a block diagram of an example system for accessing, adapting, and presenting information content to electronic devices;

FIG. 2 shows an example client device;

FIGS. 3A-3E illustrate an example scenario for navigation by a client device within a content display;

FIGS. 4A, 4B, and 4C each show an example user interface of a client device;

FIG. 5 is a flowchart depicting example functional blocks of a method for sending modified information content; and

FIG. 6 is a flowchart depicting example functional blocks of a method for displaying information content.

### DETAILED DESCRIPTION

Limited screen space and processing power of many client devices can limit navigation within a display of information content (i.e., a web page and/or other data requested for presentation on a client device). Different users of client devices may prefer different views of information content, such as a traditional browser view or a columnar/graphical format presenting specific choices to simplify navigation among information sources. Also, the information content may not be displayable on a given client device, for example, many client devices are not equipped with software for displaying video content. Further, the information content may be uncompressed, and require additional resources (e.g., memory, battery life) and time to transmit and display compared to compressed information content.

Embodiments described herein include a transformation process for providing an enhanced view of information content. The information content may be transformed to reduce information content size, and thus decrease load time of the information content on a client device. The enhanced view of information content may be applied based on a content type of the information content. Such content types may be specified as Multi-purpose Internet Mail Extension (MIME) types and/or other content-typing schemes, for example.

The information content may be transformed in various ways to reduce content size, and corresponding bandwidth requirements to transmit the information content. For example, whitespace (e.g., spaces, tabs, blank lines) may be reduced, thereby compressing the content. Image color depth reduction may shrink graphical content size by reducing a number of bits used to represent colors in the graphical content (e.g., utilize 6 bits per color per pixel instead of a standard 8 bits per color per pixel in order to reduce an image size by 25%).

Other content transformation may include enabling video display on client browsers. A server may reformat video (or other data) from an information source into a format that can be displayed by the client device. For example, the information source may include video content in an input video format, such as a Flash video format (i.e., FLV, F4V, or F4P format). The server may parse the information source to determine that video is part of the information content, determine what video formats can be displayed on the destination client device, and reformat the input video content so the client device can display reformatted video content. The server may reformat input video content in a Flash video format into video content in an MPEG4/3GPP or similar other video format displayable on the client device. The server may also replace tags in the information content to direct the client device to play the reformatted video content that is stored on the server.

The enhanced view may include a transformation of a layout of the information content. The layout may be enhanced by use of software or instructions that can be included with content sent to the client device. The instructions may be executable to display one or more navigation bars (or navbars, for short) with the information content. A navigation bar moves with a display of content as a user navigates within the information content. Thus, any operations/options provided by the navigation bar are available to the user throughout navigation within and between information sources.

A structured approach may be used to generate and customize software for navigation bars. For example, software for presentation of one or more navigation bars may include two components, such as a container and a set of one or more feature modules. The container for the given navigation bar(s) may include software that specifies general characteristics of the navigation bar(s), while the feature modules may each include software for customizable properties of the navigation bar(s).

Content delivery to the client device may be accelerated by pre-fetching data at a server in close communication with the client device. Pre-fetching includes retrieval of data from an information source by the server prior to receiving a specific request from the client device for the data. When data is requested by the client device, the server may already have the data stored and can readily transmit the data to the client device without waiting for transmission of the data from an information source.

The server may provide security services for the client device along with the enhanced view of information content. For example, the server could scan requested information content for virus detection, malicious software (a.k.a. malware)/scripting language instructions, identity theft prevention, and/or removal of sensitive data, such as telephone numbers, credit card data, or other identifying information.

### 1. An Example System for Presenting Information Content

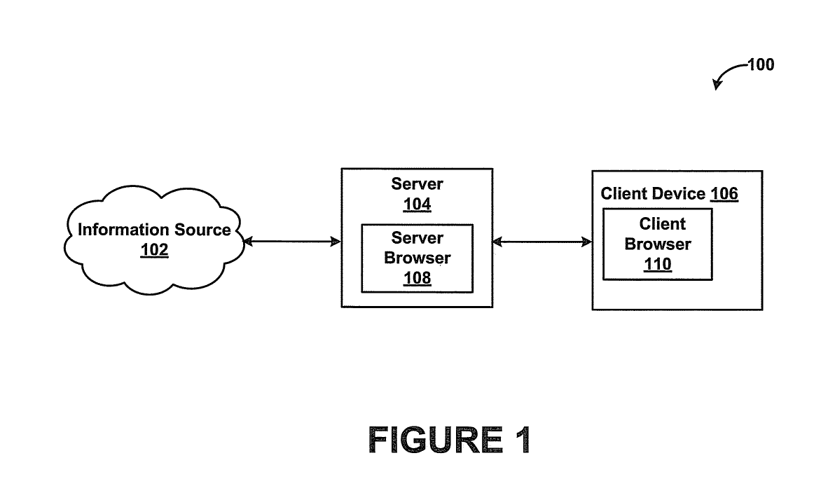

Referring now to FIG. 1, a block diagram is shown of a system 100 for accessing, adapting, and presenting information content to electronic devices. The system 100 includes an information source 102, a server 104 and a client device 106.

The information source 102 includes any type of device such as a web server, application server, database or other backend system, or any interface to an information provider. The information source 102 provides information content expressed in a markup language, such as those markup languages known in the art including HyperText Markup Language (HTML), Extensible Markup Language (XML) with or without Extensible Style Sheets (XSL), VoiceXML, Extensible Hypertext Markup Language (XHTML), or Wireless Markup Language (WML). Furthermore, the information content can reference images, video, or audio information to be provided by the information source 102.

The information source 102 can be accessed through any type of network by the server 104 via a server browser 108. The server browser 108 may communicate with the client device 106 over any type of network through a client browser 110. The server browser 108 acts as a proxy between the client browser 110 and the information source 102 of web page content for viewing. The server browser 108 may operate as a client of the information source 102 to retrieve the information content. For example, using a known suite of communications protocols such as Transmission Control Protocol/Internet Protocol (TCP/IP), the server browser 108 can issue a Hypertext Transfer Protocol (HTTP) request to the information source 102.

By utilizing HTTP requests, the server browser 108 can access information content, including applications, static and dynamic content, at the information source 102. Content, such as dynamic web pages, can be written in scripting languages such as JavaScript, developed by Netscape, Jscript, VBScript, Visual Basic, and C#, all of which were developed by Microsoft, and/or Tcl. JavaScript is also a component of Dynamic HTML (DHTML), which is an alternative technology for delivering rich internet applications with interactive animated content.

The server browser 108 and the client browser 110 may reside on the same platform or may be separate from each other. For example, the server browser 108 might be hosted on a back-end server, and the client browser 110 might be hosted on a hand-held electronic device, as shown in FIG. 1. However, it should be understood that the server browser 108 and client browser 110 can be hosted on the same platform such as on a computing device, if the platform or computing device has the appropriate hardware and network capabilities. Thus, within many embodiments herein, functionality may be described as being part of the client browser 110 or as being part of the server browser 108.

It should be understood that the client device 106 and the server 104 may co-exist on the same device, and thus functionality of either can be substituted by each other. Thus, the client browser 110 may perform functions explained as being performed by the server browser 108, and the server browser 108 may perform functions explained as being performed by the client browser 110. By utilizing the server and client browser, smaller electronic devices with limited hardware capability can access feature rich information or data.

Generally, a computing device configurable as the information source 102, the server 104 and/or the client device 106 includes one or more central processing units and/or other computer processors (e.g., microprocessor(s), digital signal processor(s), graphics processing unit(s), application-specific integrated circuit(s)), a memory (e.g., a primary and/or secondary memory unit(s)), an input interface for receiving data (e.g., one or more wired and/or wireless network interface(s)), an input interface for receiving input signals from one or more input devices (e.g., a touch screen, a keyboard, a mouse), an output interface for communications with an output device (e.g., monitor(s), display(s), printer(s)), and appropriate interconnection circuitry for the above-components (e.g., bus(es)).

In general, it should be understood that the information source 102, the server 104, and the client device 106 could include hardware objects developed using integrated circuit development technologies, or the combination of hardware and software objects that could be ordered, parameterized, and connected in a software environment to implement different functions described herein. Also, the hardware objects could communicate using electrical signals, with states of the signals representing different data.

It should also be noted that the server 104 and the client device 106 generally execute application programs resident at the server 104 and the client device 106 under the control of an operating system (e.g., Linux, Apple OS X, Microsoft Window, UNIX, variants thereof). Application programs, such as the server browser 108 and the client browser 110, may be stored on tangible computer-readable media within the server 104 and the client device 106 and may be provided using machine language instructions or software with object-oriented instructions, such as the Java programming language. However, other programming languages (e.g., the C++ programming language) could be used as well to generate machine language instructions.

The terms tangible computer-readable medium and tangible computer-readable media refer to any tangible medium, such as but not limited to the memory described above, that can be configured to store instructions, such as the machine language instructions described above for execution by a computing device. Such a medium or media may take many forms, including but not limited to, non-volatile media and volatile media. Non-volatile media includes, for example, read only memory (ROM), flash memory, magnetic-disk memory, optical-disk memory, removable-disk memory, magnetic-tape memory, hard drive devices, compact disc ROMs (CD-ROMs), direct video disc ROMs (DVD-ROMs), computer diskettes, and/or paper cards. Volatile media include dynamic memory, such as main memory, cache memory, and/or random access memory (RAM). Many other types of tangible computer-readable media are possible as well. As such, the herein-described memory may comprise and/or be one or more tangible computer-readable media.

As an example, the client browser 110 may reside on the client device 106, which may be an electronic device including any of a personal computer (PC), wireless telephone, personal digital assistant (PDA), hand-held computer, network appliance, and a wide variety of other types of electronic devices that might have navigational capability (e.g., touch screen, keyboard, mouse, etc.) and an optional display for viewing downloaded information content. Furthermore, the client device 106 can include any type of device that has the capability to utilize speech synthesis markups such as W3C Voice Extensible Markup Language (VoiceXML). One skilled in the art of computer systems will understand that the example embodiments are not limited to any particular class or model of computer employed for the client device 106 and will be able to select an appropriate system.

To provide an example illustration, assume a PDA hosts a client browser 110, a PC hosts the server browser 108, and the PDA and PC are both connected to a local area network (LAN) and/or a wide area network (WAN). Then, the client browser 110 and the server browser 108 could perform information transactions over the LAN and/or WAN. Such transactions may utilize Ethernet or similar IEEE 802.3 protocols. In this example, the client and server browsers communicate over a wired network. The communications might also include a wireless network such as a local area wireless network (LAWN) or wireless local area network (WLAN). Moreover, the communications might include wireless networks that utilize other known protocols and technologies such as Bluetooth, wireless application protocol (WAP), time division multiple access (TDMA), or code division multiple access (CDMA).

Information content from the information source 102 is retrieved and can be tailored for use on the client browser 110 by the server browser 108. Alternatively, the server browser 108 may retrieve the information content and send the information content to the client browser 110, which itself tailors the information appropriately for viewing. Content transformations may be necessary since the requested information content (e.g., a webpage) could have been initially designed for viewing on a large screen of a PC, rather than on a limited screen size of a handheld device. As a result, either the server browser 108 or the client browser 110 can perform information content transformations or apply device specific style sheets to aid in presentation (e.g., visual and/or audible output) and navigation (e.g., keyboard, touch screen, or scrolling), and perform content grouping for electronic devices that accepts data in limited quantities.

To deliver these capabilities, the server browser 108 or client browser 110 may include modules (not shown) including a user agent, cookie handler, QDOM, script executor, normalizer, and serializer, for example. Additional information pertaining to information content transformation or customization is included in U.S. Pat. No. 7,072,984, entitled “System and Method for Accessing Customized Information Over the Internet Using a Browser for a Plurality of Electronic Devices,” U.S. Pat. No. 7,500,188, entitled “System and Method for Displaying Information Content with Selective Horizontal Scrolling,” and U.S. patent application Ser No. 09/843,036, entitled “System and Method for Adapting Information Content for an Electronic Device,” the contents of each of which are incorporated herein by reference as fully set forth in this description and collectively referred to herein as the “Incorporated Applications”.

The terms transform and transformation, in the context of this application, are used to describe a process which may be implemented using computer hardware or software, to transcode, modify, update, replace, adapt, alter, convert, turn into, re-form, regenerate, rearrange, reshape, amend, and/or otherwise change information content, for example.

### 2. An Example Client Device

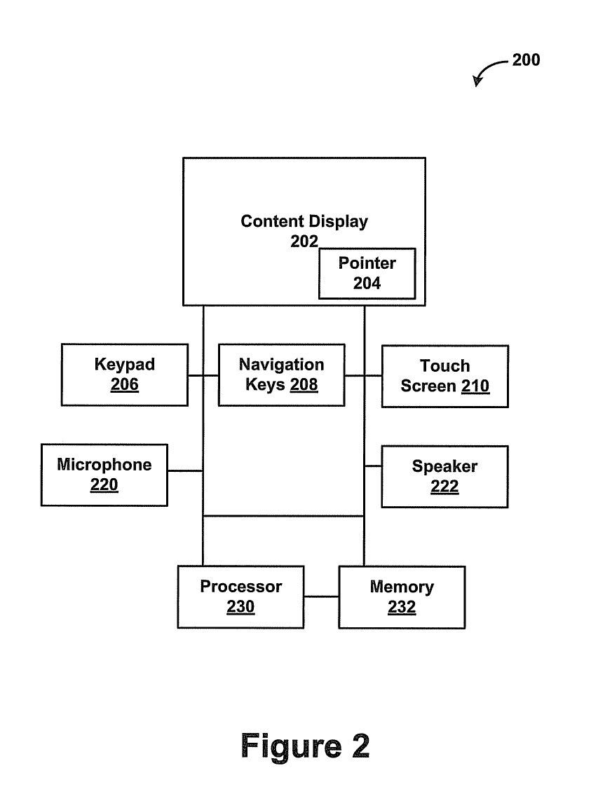

FIG. 2 shows an example client device 200. The client device 200 may be equipped with one or more graphical output devices, such as a content display 202. The content display 202 may be configured to display textual and/or graphical content. Graphical content may include a pointer 204, for example. In some embodiments, pointer 204 may act as a cursor.

The client device 200 may be equipped with various input devices, such as a keypad 206, navigation keys 208, and/or a touch screen 210. The various input and graphical output devices may be used to provide a graphical user interface for the client device 200. For example, the pointer 204 of the content display 202 may be part of an example user interface. The pointer 204 may be moved within the content display 202 according to key presses on the keypad 206 and/or the navigation keys 208. In some embodiments, the pointer 204 may be moved according to touches registered on the touch screen 210. The pointer 204 may be used to perform various user-interface operations on graphical objects, such as, but not limited to selecting, dragging, dropping, unselecting, grouping, expanding, and/or shrinking one or more graphical objects.

The client device 200 may be equipped with audio input and output devices, such as one or more microphones 220 and/or one or more speakers 222. In some embodiments, the client device 200 may communicate with one or more devices over a radio frequency (RF) air interface according to a long-range protocol such as CDMA, iDEN, Time Division Multiple Access (TDMA), AMPS, GSM, GPRS, UMTS, EDGE, WiMAX (e.g., IEEE 802.16), LTE, microwave, satellite, MMDS, Wi-Fi (e.g., IEEE 802.11), and others now known or later developed. Short-range protocols, such as Bluetooth, ZigBee, and others now known or later developed, may be used by client device 200 to communicate with other devices adhering to the short-range protocol.

The various input and output devices and objects 202, 204, 206, 208, 210, 220, and 222 may be controlled by a processor 230 and may read/write data to and from memory 232. The processor 230 may be controlled via instructions stored in memory 232 to perform the herein-described tasks and functionality of the client device 200. Processors and memory are described above in more detail with respect to FIG. 1.

### 3. Example User Interfaces for a Client Device

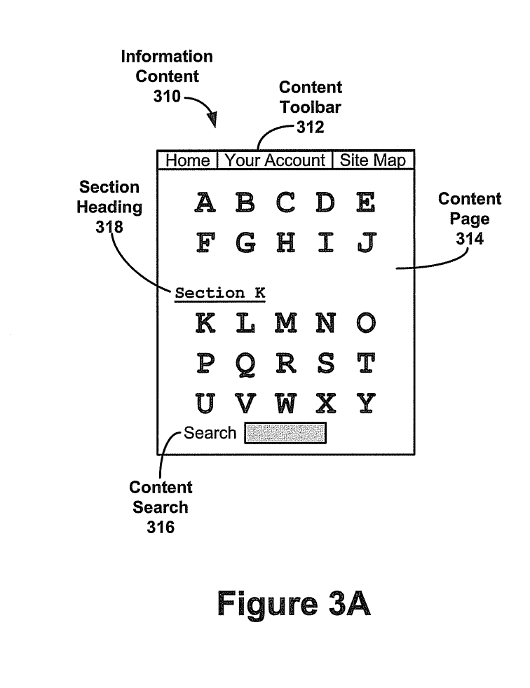

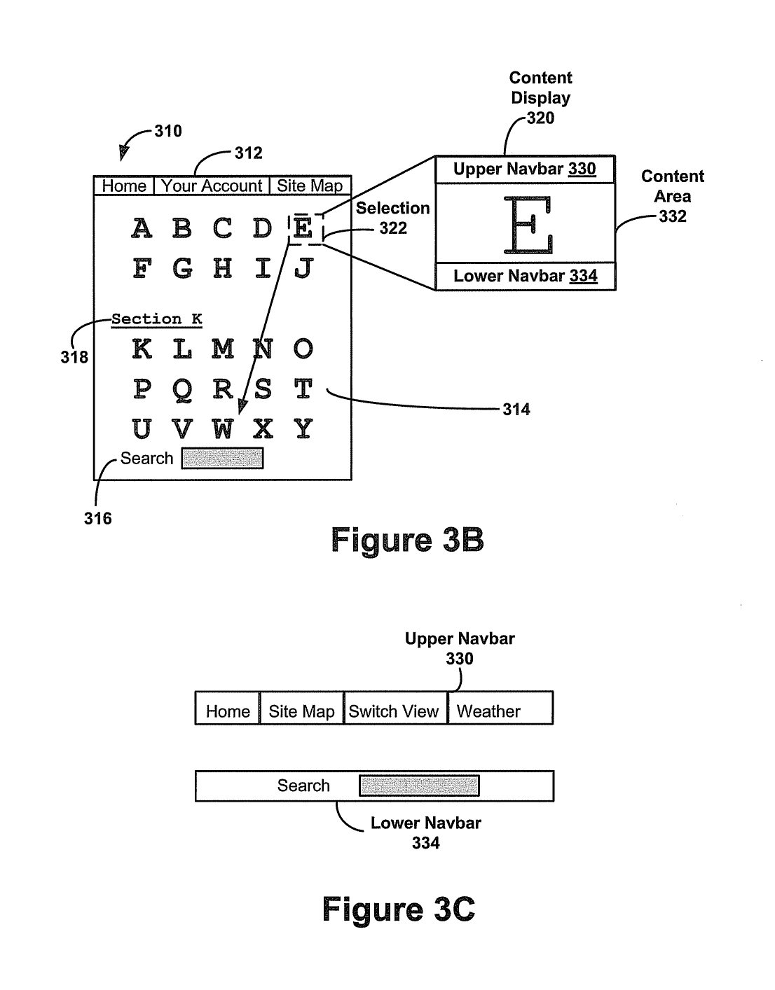

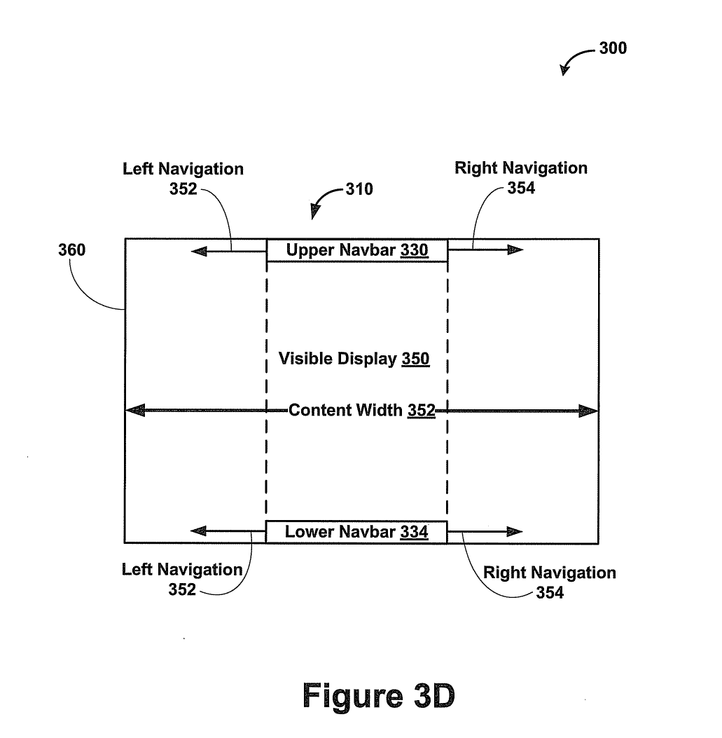

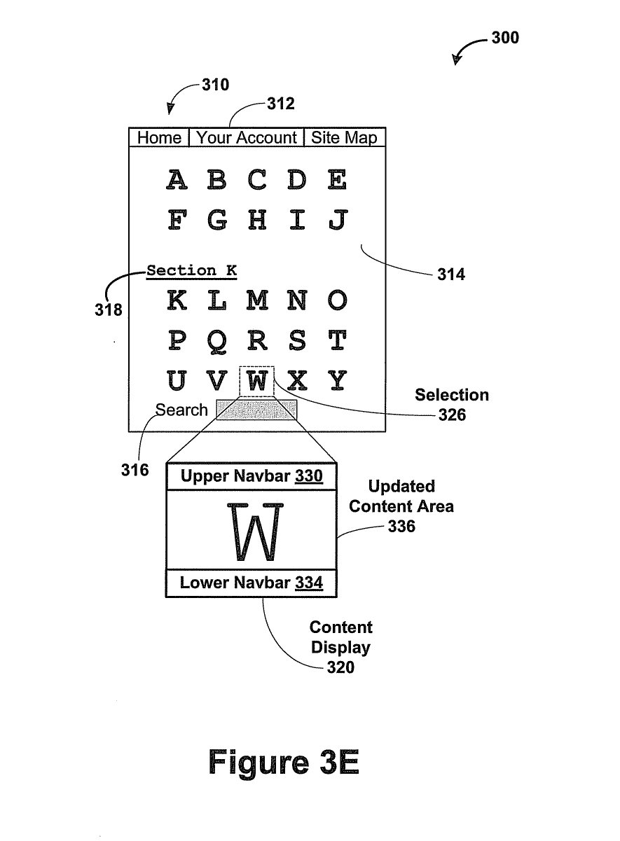

FIGS. 3A-3E together show an example scenario for navigation and display of information content by a client device 106.

FIG. 3A shows an example of requested information content 310, including a content toolbar 312, a main content page 314, a content search box 316, and a section heading 318. The information content 310 may be content (e.g., a web page) retrieved from an information source. In FIG. 3A, the information content 310 is shown displayed in its entirety as may be performed using a standard personal computer monitor, for example.

The content toolbar 312 may be configured with one or more links to permit navigation within the information content 310 and/or within one or more information sources associated with the information content 310. FIG. 3 shows the content toolbar 312 to include with “Home”, “Your Account”, and “Site Map” links/buttons. These three links may permit a user to navigate to a home location, an account setup/profile location, and a web-site overview page, respectively. It is to be understood that the content toolbar 312 may be equipped with more, fewer, and/or different links/buttons as well. Each link or button shown on the content toolbar 312 may be displayed using textual and/or graphical content. While FIG. 3A shows the information content 310 with one content toolbar 312, the information content 310 may include either no content toolbars or multiple content toolbars.

The content page 314 may include a body of information content, such as textual content, graphical, audio, video, and/or other types of content as normally provided within typical web pages.

The content search 316 may enable locating of information within the information content 310 and/or within one or more information sources associated with the information content 310 via entry of keyword(s) in a search box of the content search 316. Upon entry of the keyword(s), an information source may provide information content matching the keyword(s) for display on a client device.

The section heading 318 may be used to separate portions of the information content 310, such as portions of the content page 314. As shown in FIG. 3A, the section heading 318 may indicate a lower portion of content page 314 as “Section K”. Section headings may be specified using one or more HTML instructions, such as a HEAD element, for example.

The content toolbar 312, the content page 314, the content search 316, and/or the section heading 318 may be generated via one or more scripting languages, operating systems, programming languages, and/or machine language instructions. In particular, the content toolbar 312, the content page 314, the content search 316, and/or the section heading 318 may be partially or wholly generated using markup language (e.g., HTML) instructions.

FIG. 3B illustrates the information content 310 and a display of the information content 310 on a content display 320. Because the content display 320 is small, the client device display 320 cannot display the entirety of the information content 310. As shown in FIG. 3B, for example, only a small portion of the information content 310 may be viewed on the client device display 320 at any given time.

A user may make a selection 322 of the information content 310 to view a specific portion of the information content 310. As shown in FIG. 3B, the selection 322 includes the letter “E” wholly included in the content page 314 of the information content 310. The selection 322 indicates the portion of the information content 310 visible to a user of the client device.

The content display 320 is shown to the right of the selection 322 in FIG. 3B. The client display 320 includes an upper navigation bar 330, a content area 332, and a lower navigation bar 334.

As shown in FIG. 3B, when the information content 310 is viewed on the client device display 320, navigation bars 330 and 334 may be generated and included for the user. The navigation bars 330 and 334 provide additional functionality via a readily accessible interface rather than via a traditional menu. The navigation bars may be configured to be displayed in different positions on the client device display 320 (e.g., top, right, bottom, left). FIG. 3B shows navigation bars 330 and 334 at upper and lower positions, respectively, of the content device display 320.

FIG. 3C illustrate an example of content within the upper navigation bar 330 and the lower navigation bar content 334. The upper navigation bar 330 may include hyperlinks such as the four links “Home”, “Site Map”, “Switch View”, and “Weather”. The upper navigation bar 330 may include more or fewer links than shown in FIG. 3C.

Links of a navigation bar, such as shown in upper navigation bar content 340 and lower navigation bar content 342, may contain icons, images, options, selections, entry boxes, and/or Uniform Resource Locators (URLs) for a number of functions beyond those described above, such as but not limited to, navigating to another webpage/URL, viewing a snapshot/thumbnail of the information content 310, saving a link to the information content 310 as a favorite/bookmarked page, accessing a favorites/bookmarks page, and/or adding a RSS and/or content feed(s) associated with the information content 310 to a list of feeds available, move within the information content 310, enter login/password data, and changing user settings/profile information (such as font size/style, content adaptation, text/image display, audio settings, image color depth, or other image quality settings), for example.

The Home link and the Site Map link of the upper navigation bar 330 may include functionality of the corresponding links of the content toolbar 312. The “Weather” link may provide information about current weather conditions. The “Switch View” link may enable a user to switch views of information content. One view, a “handheld view”, may include transforming the information content into segments, where each segment is configured to fit in the client device display 320. Another view, a “browser view”, may provide information content without segmentation. The information content of FIGS. 3A, 3B, and 3D is shown using a browser view, for example.

The upper navigation bar 330 may provide link(s), such as the Home and Site Map links, that are based on the information content 310, and link(s), such as the Weather and Switch View links, that are not based on the information content 310.

FIG. 3C also illustrates the lower navigation bar 334 including a search box allowing for entry of search information (e.g., keywords). Upon entry of the search information, the functionality of the content search 316 may be used to provide the same information as if entered as search information at the bottom of the information content 310.

As shown in FIG. 3B, the lower navigation bar 334 is visible to a user of the client display device 320. As the lower navigation bar 334 includes the functionality of the search box 316, this functionality may be readily accessible to the user even though the user may not be viewing the portion of the information content 310 that includes the search box 316.

In some embodiments, the search functionality provided by a navigation bar may be different from content provided by the information content 310. For example, the search functionality may allow searching within the information content 310 or use a different information source for search functionality.

The functionality used by the links in the upper navigation bar 330 and/or the lower navigation bar 334, including the search box of lower navigation bar 334, may be chosen by a server (e.g., the server 104) based on a number of selection criteria. Some of these criteria may be customizable by a user and stored in a user profile accessible to the server, as discussed above. For example, the Weather link may be provided based on a user selection in a user profile requesting weather information on a navigation bar.

In some embodiments, the server may maintain records of software applications already available on a particular client device. Based on the records of available software, the server may provide instruction with link(s) in the upper navigation bar 330 and/or the lower navigation bar 334 that use the application on the particular client device. For example, the server may have a software application record that a particular client device has Google toolbar functionality already installed. Then, the server may provide the particular client device with a search box link that uses the Google toolbar functionality already on the particular client device. The server may update the records of available software based on software downloaded via the server to the particular client device.

The server may determine selection criteria by parsing and/or otherwise processing the information content 310. By parsing the information content 310, the server may discover functionality of information content; e.g. the Home and Site Map functionality of information content 310 shown in FIG. 3B. Then, the server may provide links corresponding to functionality discovered during parsing/processing of the parsed information content; e.g., the Home and Site Map links of the upper navigation bar 330 shown in FIG. 3C.

FIG. 3D shows a conceptual layout of the information content 310 and illustrates how the navigation toolbars 330 and 334 may be displayed on a visible display 350 of a client device during user navigation. The navigation bars 330 and 334 may horizontally and/or vertically navigate along with selections of information content. For example, suppose the user were to start at a leftmost border 360 of the information content 310 and then scroll right (i.e., in a direction of right navigation 354) and stop at a midpoint of the information content for a selection. The navigation bars 330 and 334 would float such that the navigation bars 330 and 334 move from left to right and still appear in the upper and lower portions of the visible display 350. Similarly, if the user were to scroll left (i.e., in a direction of left navigation 352), the navigation bars 330 and 334 would float left along with the selection. While not shown in FIG. 3D, similar functionality may be used to float the navigation bars 330 and 334 during vertical navigation of the information content 310.

FIG. 3E illustrates a selection 326 after navigation. The client device display 320 includes the upper navigation bar 330 and lower navigation bar 334 displayed above and below, respectively, updated content area 336 that corresponds to content of the selection 326. The updated content area 336 shows the letter “W” selected. No matter where the user navigates to horizontally and/or vertically within the information content 310, the navigation bar(s) 330 and 334 may follow as part of the client device display 320 once navigation has ceased.

By maintaining navigation bars constant throughout navigation of information content, the navigation bars increase the content that can be made available to the user, and ease the ability of a user to use the information content.

To implement functionality of navigation bar(s) described above, software instructions may be added to requested information content. A server may retrieve the requested information content from an information source, add the software instructions for displaying the navigation bars to the retrieved information content, and then send the modified information content to the client device. The software instructions may include JavaScript language and/or other machine-executable instructions that direct the client device to display the navigation bars in the content display. In some embodiments, the navigation bar(s) may be added in one or more frames of a display separate from the display of information content.

Layout and content of each navigation bar may be customized according to a user profile stored on the client device 106 and/or server 108. Such customizations may include specific links to be included in the navigation bars, graphical properties of the navigation bar(s) (e.g., size, shape, color), and or a theme or overall appearance/layout of the navigation bar(s).

The server 104 may also customize the navigation bar(s) as well based on the requested information content and/or customization rules. For one example, the server may use instructions to provide a search function, such as shown in the lower navigation bar content 334 of FIG. 3C, after determining that information content has a search function, such as the content search 316. A server profile may have customization rules to determine a layout and/or content of the navigation bar(s) based on the client device 106.

Other customization rules may determine if advertising or other content is to be added to the navigation bar(s). Theme-based customization rules may statically or dynamically apply a theme to navigation bar(s) to match the colors and styles of the information content display and/or as requested for various operators.

In one embodiment, customization rules are provided to enable generation and customization of navigation bars. For example, one or more given navigation bars may each be generated according to content instructions and a set of one or more feature modules.

The content instructions may specify general characteristics of the navigation bars(s), such as for example, how/where the navigation bar(s) are displayed. In particular, the content instructions may specify one or more instructions that control navigation bar(s) and/or support implementation of the navigation bar(s) on the client device. A loading order for content may be specified via the content instructions, such as for example, information content may be presented on a client display before a navigation bar is presented.

Other functions may be provided by the content instructions, such as rotation/resizing of toolbars for client devices that allow screen rotation may be implemented as content instructions as well. Auto scaling, or control of page magnification to ensure a navigation bar is displayed in an appropriate font size, may be provided via container instruction(s). Auto-scaling may make sure navigation bar font(s) are visible in light of any page-magnification instructions in requested information content that may reduce or increase navigation bar font(s) to be unreadable or unusable. Container instructions for caching rules may specify storage locations, parameters, and/or objects.

The content instructions may also insure installation of supporting software required to support display of the navigation bars. For example, JavaScript and/or other software can be loaded on the client device. If supporting software is not already loaded on the client device, the container instructions may provide link(s) and/or advice to allow a user to download or otherwise obtain any necessary supporting software.

Feature modules for customization of navigation bars may be divided into categories, such as (a) fixed modules (no modification or customization allowed by the end user), (b) search/status modules (enable navigation to other web sites), (c) site-sharing modules (enable sharing of links to sites), (d) indicator modules (provide key information as indicator(s)), and (e) theme modules (allow specification of themes for navigation bar display). Other categories of feature modules are possible as well.

Example feature modules include:

(1) A home link feature module that instructs the client device to display a portal or home page of an information source. For example, the “Home” link and/or the “Site Map” link shown in lower navigation bar 334 may be implemented using one or more home link fixed feature modules.

(2) A quick link feature module that causes a direct selection of a given section on the information content. For example, if the “Section K” heading 318 of FIGS. 3A, 3B, and 3E is identified as a section within the information content 310, the quick link module may utilize a scrollTo ( ) JavaScript method and/or other software techniques to jump directly to the portion of the information content identified as “Section K” of FIGS. 3A, 3B, and 3E.

(3) One or more view selection feature modules that enable different content formats. For example, view selection fixed feature modules enable a choice of a handheld view to configure information content to fit in a client device display. Another view choice may be a browser view that provides information content without segmentation. Other view choices or view selection modules may be possible as well. As an example, the Switch View link of the lower navigation bar 334 may allow a user to switch between the handheld view and the browser view of the information content 310 using one more view selection fixed feature modules.

(4) A secure page indicator feature module that indicates that part or all of information content is requested to be in a secure mode.

(5) A feed indicator feature module that identifies any Really Simple Syndication (RSS) and/or content feed(s) on a page and provides access to the identified feed(s).

(6) A bookmark feature module to permit storage of web sites. One example bookmark module may provide a button or other selector for bookmarking a current webpage and/or menu, such as a drop down menu that dynamically loads saved bookmarks as a list for fast access. The bookmark fixed feature module may include access to external bookmarking system(s) for storage and/or access of bookmarked website. The bookmark fixed feature module may also allow a user to tag (i.e., add label(s) to) a web site.

(7) A fixed graphic feature module that may provide advertising and/or wireless service provider information into toolbars as pre-determined graphical and/or textual content.

(8) A selector feature module that may enable selection of information content, including but not limited to selecting a portion of displayed information content, storing the selected portion of information content to an internal buffer and then retrieving content from the internal butter (a.k.a. cutting and pasting), selecting a new portion of displayed information content for storage in the internal buffer, editing of selected information content, dragging and dropping selected portions of information content into navigation bars (as text entry) and/or into data entry fields of information sources, and/or other operations on selected information content.

(8) A selector fixed feature module that may enable selection of information content, including but not limited to, selecting a portion of displayed information content, storing the selected portion of information content to an internal buffer and retrieving content from the internal butter (e.g., cutting and pasting), selecting a new portion of displayed information content for storage in the internal buffer, editing of selected information content, dragging and dropping selected portions of information content into navigation bars (as text entry) and/or into data entry fields of information sources, and/or other operations on selected information content.

(9) A search feature module that provides a goto-URL search/status feature to permit a user to enter a Uniform Resource Locator (URL) and then use the entered URL to access information content. Another example search/status feature module may be an Internet-search module that permits entry of keywords either directly via text entry and/or via selection among a list of predetermined keywords. Once the keywords are entered, a search function of a web site and/or a search engine web site is accessed to perform a search using the entered keywords. In some embodiments, the internet-search status/feature module may provide a mashup or aggregation of search results from multiple search engines. A security search/status feature module may permit entry of and/or updates to security credentials (e.g., login/password information, encryption key information), perhaps as required by information sources.

(10) A status-update feature module may permit specifying a status and then using the specified status to update a status indicator on one or more websites. A find-on-page search/status feature module may be used to permits entry of keywords and then highlight or otherwise identify the entered keywords within the current information content, such as the information content 310 of FIGS. 3A-3E. For example, the search box shown as lower navigation bar 334 may be implemented using a search/status feature module (e.g., an internet-search search/status module, a find-on-page search/status module). Many other search/status modules are possible as well.

(11) A site-sharing feature module that enables sharing of links to one or more site-sharing web sites. The site-sharing feature module(s) may format an appropriate command to a site-sharing web site (e.g., a HTTP GET command with the current site address as a query string). The site-sharing web site may then with an information source configured to enter data related to the sharing request (e.g., title, friends to share with, comments). For example, each site-sharing feature module may access a different predetermined site-sharing web site. In other embodiments, a site-sharing feature module may permit specifying a site-sharing web site as well as the data related to the sharing request.

(12) An indicator feature module to provide the user with updates to key information in the form of a simple indicator. For example, each indicator module may display a small amount of text and/or an icon on the toolbar as an indicator and may allow access to additional information upon selection of the indicator. Such indicators do not take up much space on the screen and may provide the additional information by linking to another information source and/or software widgets. Indicator modules may provide indicators for and enable access to e-mail, voice mail, short messaging service (SMS)/text messaging, weather, news, financial information, and/or social networking status identifiers. Many other indicator modules are possible as well. In some embodiments, an indicator module may provide an indication of and/or access to multiple information sources, such as a unified e-mail indicator for indicating new e-mail in one of multiple e-mail accounts and then allowing access to the e-mail account(s) with new e-mail.

(13) A theme feature module that includes a color scheme may allow selection of one or more color schemes (e.g. background and/or foreground colors) of navigation bar(s). Font theme feature modules may allow selection of font(s), including but not limited to, types and sizes of font(s), used in navigation bar(s). Text/graphics theme modules may allow selection of text and/or graphical content to be displayed on navigation bar(s); e.g., selection of a picture of a house or the word “Home” for a home link. Text/graphics theme modules may include language selections; e.g., permit selection of navigation bar terminology in English, Spanish, or French for client devices in the North American market.

(14) An audio theme feature module may allow selection of tones, songs and/or other audio data to be associate with navigation bar(s), such as audio data associated with making a selection on a navigation bar, associating audio data with indicators (e.g., playing a beep/tone when an e-mail or other indicator (including a unified e-mail indicator) indicates a change in state, such as when an e-mail or other message is received). Many other theme modules are possible as well.

In some embodiments, some or all of the above-mentioned theme feature modules may be fixed feature modules. Fixing feature modules and/or themes may enable an advertiser, carrier, wireless provider or other entity to provide a uniform user experience via commonly-used themes in navigation bars.

The feature module(s) specify functionality that can be customized in different ways/combinations depending on the toolbar implementation. For example, a particular function or feature may be provided using multiple navigation bars, multiple sections on a single navigation bar, graphically using icons, or textually, and so on. As discussed above, a user profile may track an individual user's customization/feature module selection for the given navigation bar(s). Feature modules can be loaded asynchronously, perhaps using Asynchronous JavaScript and eXtended Markup Language (XML) or AJAX for short, to speed loading of requested information content.

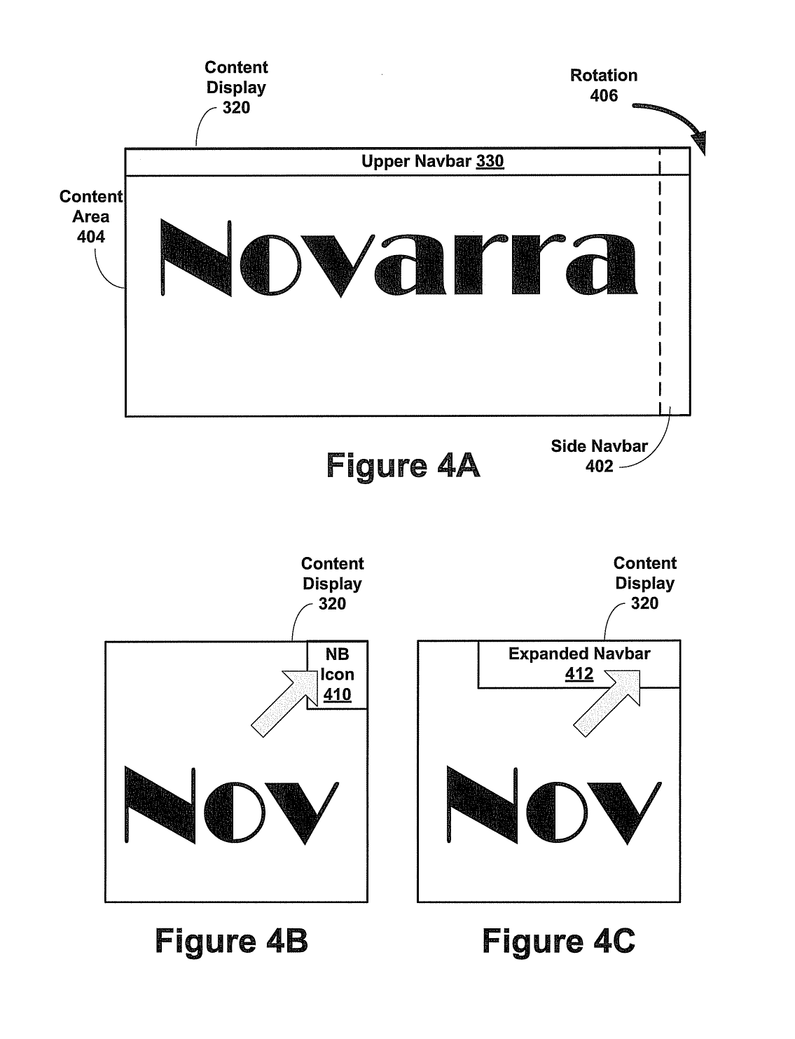

FIGS. 4A, 4B, and 4C show additional examples of a user interface for a client device. In FIG. 4A, the client device display includes the upper navigation bar 330 and a side navigation bar 402 (shown using a dashed line). The side navigation bar 402 may be displayed on either a right or left side of the client device display 320. In some embodiments, navigation bars may rotate as a client device rotates. For example, the client device may be moved to rotate a content area 404 along a direction of rotation 406 to display the content of the upper navigation bar 330 within the location of the navigation bar 402. Generally speaking, upper, lower, and/or side navigation bars may be displayed simultaneously as part of the content area 404, for example.

FIGS. 4B and 4C depict an example use of an expanding or expandable navigation bar. An expandable navigation bar may be minimized as an icon or other displayable object until selected, and then contents of the expandable navigation bar may be displayed. In contrast, the navigation bars of FIGS. 3 and 4A may be described as fixed or having a constant size on the content display.

FIG. 4B shows a navigation bar (NB) icon 410 that may provide graphical and/or textual content indicating a navigation bar. The navigation bar icon 410 may float with displayed information content similar to the floating of navigation bars discussed above for FIGS. 3A-3E. FIG. 4B shows navigation bar icon 410 in the upper-right-hand corner of the display. In other scenarios, the navigation bar icon 410 may be displayed at other positions of the display (e.g., upper-left-hand corner, centered along the top/bottom/side of the display).

In some embodiments, multiple icons (and consequent expanded navigation bars) may be present on the display. The location, size, and/or displayed graphical/textual content of navigation bar icon 410 may be selected based on a user profile and/or a server, such as described above with respect to FIGS. 3A-3E in the context of navigation bar selections.

The navigation bar icon 410 may be selected by clicking on and/or hovering a cursor over the navigation bar icon 410. Hovering over the navigation bar icon 410 involves placing a cursor, pointer, or other selector over the navigation bar icon 410 for at least a predetermined period of time (e.g., five seconds). Once navigation bar icon 410 has been selected, the client device display 320 may show an expanded navigation bar, such as an expanded navigation bar 412 shown in FIG. 4C. The expanded navigation bar 412 may include some or all of the customizable functionality of navigation bars described above with respect to FIGS. 3 and 4A.

Expanded navigation bar 412 may retract or shrink in size into the navigation bar icon 410 if the expanded navigation bar 412 is no longer selected; e.g., a mouse curser is no longer hovering over the expanded navigation bar 412. The expanded navigation bar 412 may also retract based on a selection of a link, such as a retract bar or similar link permitting a user to explicitly retract the expanded navigation bar 412. Similarly, the expanded navigation bar 412 may have a specific link, such as a fix bar or similar link, permitting the user to explicitly maintain the expanded navigation bar 412 on the client device display.

In embodiments not shown in FIGS. 4B and 4C, multiple icons and corresponding expanded navigation bars may be provided. For example, to replicate the functionality shown in FIGS. 3B-3E with expanded navigation bars, two icons and corresponding expanded navigation bars may be used—one for an expandable version of the upper navigation bar 330 and one for an expandable version of the lower navigation bar 334.

Thus, the user may readily toggle between a navigation bar icon and an expanded navigation bar. The use of customizable expanded navigation bar(s) may provide resources to a user to fully utilize an information source without being forced to jump to or navigate within an information source to access the desired content and minimize the amount of display area covered by the navigation bar(s).

### 4. A Method for Sending Modified Information Content

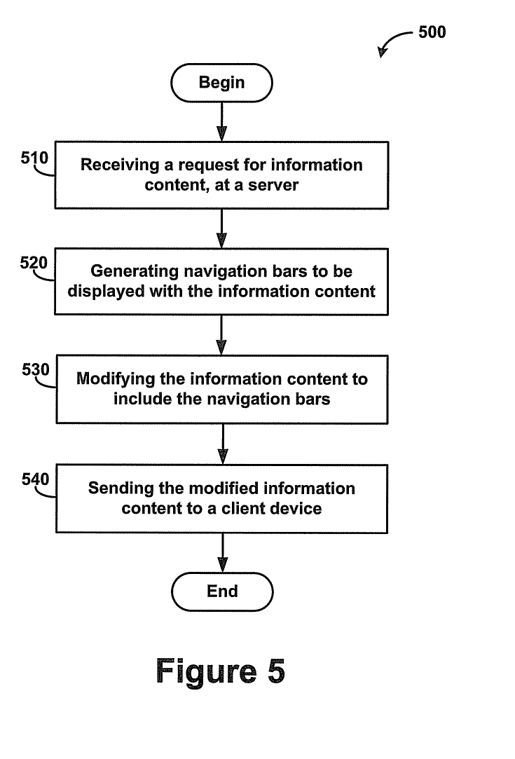

FIG. 5 is a flowchart depicting example functional blocks of a method 500 for sending modified information content to a client device. It should be understood that each block in this flowchart and within the other flowcharts presented herein may represent a module, segment, or portion of computer program code, which includes one or more executable instructions for implementing specific logical functions or steps in the process. Additionally or instead, each block in this flowchart and within the other flowcharts presented herein may represent a module, segment, or portion of computer hardware, which includes circuitry and/or logic for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

Initially, as shown at block 510, a request for information content may be received at a server. The request for information content may include a URL. The requested information content may be textual, audio, visual, and/or other types (e.g., binary) content. The server may be a computing device, such as described above for FIG. 1.

The server may retrieve the requested information content and then generate navigation bars to be displayed with the information content, as shown at block 520. The server may generate the navigation bars according to user customization methods described above.

The server may then modify the information content to include the navigation bars, as shown at block 530. For example, the server may modify the information content to include instructions to display an upper navigation bar and a lower navigation bar, as shown in FIGS. 3, for example. The instructions may indicate display of at least a portion of the information content between the upper navigation bar and the lower navigation bar, for example, or with one or more side navigation bars. Links in the navigation bars may be based on selection criteria; e.g., user profiles, records of software applications, and/or functionality discovered by parsing the information content.

The instructions may enable the upper navigation bar and the lower navigation bar to move vertically and horizontally from a first portion of the information content to a second portion of the information content as a user navigates through the information content. For example, the instructions may enable the upper navigation bar and the lower navigation bar to float as the user scrolls through the information content.

The instructions may be in the form of one or more scripting languages, markup languages, and/or executable code, such as described with respect to FIG. 1. In particular, the instructions may include HTTP, HTML, XML, and/or JavaScript instructions. The navigation bar may include one or more navigation bars, such as an upper navigation bar, a lower navigation bar, and/or side navigation bar(s), such as described above with respect to FIGS. 3, 4A, 4B, and 4C. The navigation bars may be generated using content instructions and/or feature modules, such as described above with respect to FIGS. 3. The navigation bar(s) may include one or more expandable navigation bars and related navigation bar icons, such as described above with respect to FIGS. 4B and 4C.

The server may further transform the information content in other ways, such as but not limited to, performing whitespace reduction, image color depth reduction, enable video display, and/or reformatting the information content for a client display (e.g., providing a handheld view of the content). The transformed information content may require less bandwidth, and therefore less time, to be sent from the server than non-transformed information content. Additionally or instead, the information content may be pre-fetched at the server as described above to speed delivery of the information content.

The server may then send the modified information content to a client device, as shown at block 540.

### 5. A Method for Displaying Information Content

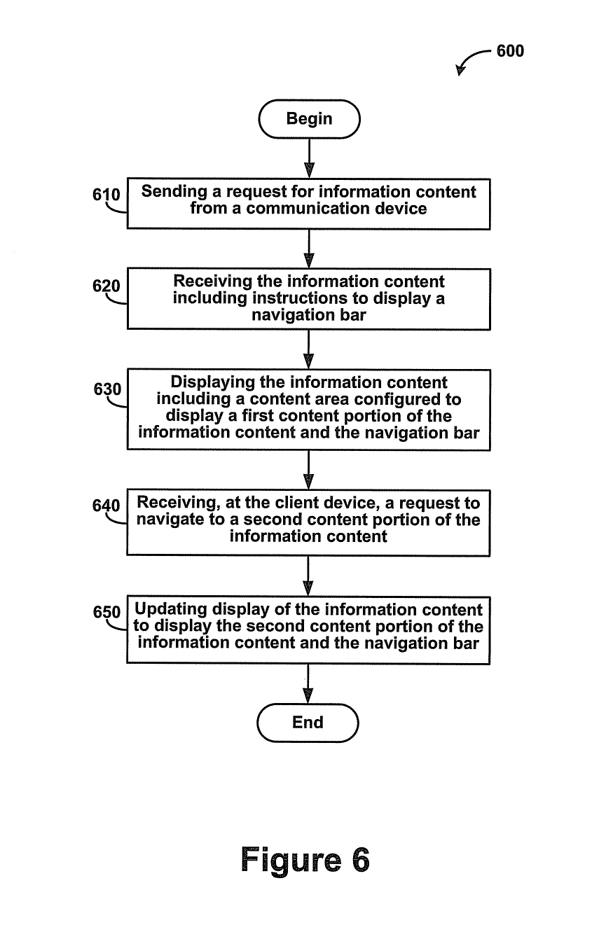

FIG. 6 is a flowchart depicting example functional blocks of a method 600 for displaying information content. Initially, as shown at block 610, a client device sends a request for information content. The client device may be a computing device, such as described above with respect to FIG. 1, and may include the functionality of the client device as described above with respect to FIGS. 1 and 2. The requested information content may be textual, audio, visual, and/or other types (e.g., binary) content. The request for information content may include a URL.

As shown at block 620, the client device may receive the information content in response to the request. The information content may include instructions for displaying the information content with navigation bars. The instructions may be in the form of one or more scripting languages, markup languages, and/or executable code, such as described with respect to FIG. 1. The navigation bar may include one or more navigation bars, such as an upper navigation bar, a lower navigation bar, and/or side navigation bar(s), such as described above with respect to FIGS. 3, 4A, 4B, and 4C. The navigation bars may be generated using a web-assist approach, including use of containers and/or feature modules, such as described above with respect to FIG. 3. The navigation bar(s) may include one or more expandable navigation bars and related navigation bar icons, such as described above with respect to FIGS. 4B and 4C.

As shown at block 630, the client device may display the information content including a content area configured to display a first content portion of the information content, and the navigation bar. The content display, content area, and navigation bar may be as described above with respect to FIGS. 2, 3, 4A, 4B, and/or 4C.

As shown block 640, the client device may receive a request to navigate to a second content portion of the information content. The request to navigate may be a request to move within a page of the information content, such as described above with respect to FIG. 3.

As shown at block 650, in response to the request to navigate, the client device may update the displayed content. The updated display content may include the content area configured to display the second content portion of the information content and the navigation bar, such as described above with respect to FIGS. 3, 4A, 4B, and 4C.

Thus, the client device enables the navigation bars to float and follow navigation through the information content so as to remain on a display of the client device during and after navigation, for example.

### 6. Conclusion

Although the present application has been described using scripting command instructions including JavaScript commands, other types of scripting commands may also be used. For example, scripting commands written in languages such as JScript, VBScript, Visual Basic, and/or Tcl, among others, may be used. It should be understood that the programs, processes, methods and systems described herein are not related or limited to any particular type of computer or network system (hardware or software), unless indicated otherwise. Various types of general purpose or specialized computer systems may be used with or perform operations in accordance with the teachings described herein.

It should be further understood that this and other arrangements described herein are for purposes of example only. As such, those skilled in the art will appreciate that other arrangements and other elements (e.g., machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

In view of the wide variety of embodiments to which the principles of the present application can be applied, it should be understood that the illustrated embodiments are examples only, and should not be taken as limiting the scope of the present application. For example, the steps of the flow diagrams may be taken in sequences other than those described, and more or fewer elements may be used in the block diagrams. While various elements of embodiments have been described as being implemented in software, in other embodiments hardware or firmware implementations may alternatively be used, and vice-versa.

The claims should not be read as limited to the described order or elements unless stated to that effect. Therefore, all embodiments that come within the scope and spirit of the following claims and equivalents thereto are claimed.

What is claimed is:

1. A method, comprising:
receiving a request for information content at a server;
retrieving the requested information content;
modifying the information content to include instructions to display the information content with a first navigation bar and a second navigation bar, wherein at least a portion of the information content is displayed between the first navigation bar and the second navigation bar, wherein the first navigation bar comprises a plurality of links including a first link based on the information content; and
sending the modified information content from the server.

2. The method of claim 1, wherein the first navigation bar is configured to be an expandable navigation bar.

3. The method of claim 1, wherein the instructions comprise HyperText Markup Language (HTML) instructions.

4. The method of claim 1, wherein the instructions comprise instructions to enable the first navigation bar and the second navigation bar to move vertically and horizontally from a first portion of the information content to a second portion of the information content as a user navigates through the information content, wherein the at least the portion of the information content remains between the first navigation bar and the second navigation bar during navigation.

5. A method, comprising:
receiving information content at a client device, the information content including instructions configured to display the information content with a first navigation bar and a second navigation bar, wherein at least a portion of the information content is displayed on the client device between the first navigation bar and the second navigation bar, and wherein the first navigation bar comprises a plurality of links including a first link based on the information content; and
enabling the first navigation bar and the second navigation bar to move vertically and horizontally from a first portion of the information content to a second portion of the information content as a user navigates through the information content, wherein the at least the portion of the information content remains between the first navigation bar and the second navigation bar during navigation.

6. The method of claim 5, wherein the instructions comprise a HyperText Markup Language (HTML) instruction.

7. The method of claim 5, wherein the information content includes a content toolbar and wherein the upper navigation bar includes a selection from the content toolbar of the information content.

8. The method of claim 5, wherein the first navigation bar comprises a floating-navigation bar icon.

9. The method of claim 8, further comprising:
receiving a first notification of a cursor hovering over the floating-navigation bar icon; and
responsive to the first notification of hovering, displaying an expandable navigation bar.

10. The method of claim 9, further comprising:
receiving a second notification of a cursor hovering over a portion of the information content that does not include the expandable navigation bar; and
responsive to the second notification of hovering, removing a display of the expandable navigation bar.

11. The method of claim 5, wherein the first navigation bar comprises an upper navigation bar that is displayed at a top of a display on the client device, and wherein the second navigation bar comprises a lower navigation bar that is displayed at a bottom of the display on the client device.

12. The method of claim 5, wherein the first navigation bar comprises a side navigation bar that is displayed at a right side or a left side of a display on the client device.

13. The method of claim 5, wherein the second navigation bar comprises a search box.

14. The method of claim 5, further comprising first loading the information content on a display of the client device, and subsequently loading the first navigation bar and the second navigation bar on the display of the client device.

15. The method of claim 5, wherein content of the first navigation bar and the second navigation bar is customizable by a user of the client device, and wherein the plurality of links of the first navigation bar comprises a second link based on a selection by the user and a third link based on a software application already available on the client device.

16. A system, comprising:
a processor; and
a memory, configured to store instructions that, in response to execution by the processor, cause the system to perform operations comprising:
receiving information content including instructions to display the information content with a first navigation bar and a second navigation bar, wherein at least a portion of the information content is displayed between the first navigation bar and the second navigation bar, wherein the first navigation bar comprises a plurality of links including a first link based on the information content, and
enabling the first navigation bar and the second navigation bar to move vertically and horizontally from a first portion of the information content to a second portion of the information content as a user navigates through the information content, wherein the information content remains between the first navigation bar and the second navigation bar during navigation.

17. The system of claim 16, wherein the first navigation bar is configured to be an expandable navigation bar.

18. The system of claim 16, wherein the first navigation bar comprises an upper navigation bar and wherein the second navigation bar comprises a lower navigation bar.

19. The system of claim 16, wherein the instructions comprise HyperText Markup Language (HTML) instructions.

20. The system of claim 16, wherein the operations further comprise first loading the information content on a display, and subsequently loading the first navigation bar and the second navigation bar on the display.
